(19) United States
(12) Patent Application Publication
(10) Pub. No.: US 2017/0186090 A1
(43) Pub. Date: Jun. 29, 2017

(54) IMPERFECT MARKET DATA ENHANCEMENT AND CORRECTION

(71) Applicant: iCharts, Inc., Mountain View, CA (US)

(72) Inventors: Seymour Duncker, Los Altos, CA (US); Stephane Gamard, Geneva (CH)

(21) Appl. No.: 15/213,187

(22) Filed: Jul. 18, 2016

Related U.S. Application Data
(60) Provisional application No. 62/272,025, filed on Dec. 28, 2015.

(51) Int. Cl. G06Q 40/06; H04L 29/08; G06F 17/30

(52) U.S. Cl. CPC G06Q 40/06; G06F 17/30371; H04L 67/06; G06F 17/30076

(57) ABSTRACT

Market data is often provided as inhomogeneous imperfect data with inconsistent granularity and hierarchical entries. Data processing operations may be performed by a user device or by a server coupled to a user device to transform the imperfect market data into perfect market data with consistent granularity where all entries are leaf nodes with no subordinate entries. The data processing includes data correction operations identify provided parent values of parent entries, the parent values based on sets of child values of child entries that are subordinate to the corresponding parent entry (e.g., representing sums, products, minimums, maximums, etc. of the child values) and compare these parent values to calculated values of corresponding operations performed on the provided child values. Additional entries may be generated to absorb any discrepancies identified in these comparisons. Parent nodes can then be removed to remove redundant information and provide uniformity to the market data.

### CROSS-REFERENCE TO RELATED APPLICATIONS

This application claims the priority benefit of U.S. provisional application 62/272,025 filed Dec. 28, 2015, the disclosure of which is incorporated herein by reference.

### BACKGROUND OF THE INVENTION

Field of the Invention

The present invention generally relates to market data analysis and transformation. More specifically, the present invention relates to generating perfect market data out of imperfect market data using data enhancement and data correction operations.

Description of the Related Art

Market data is typically ordered from an aggregator service, such as Nielsen, that may gather a portion of the market data and may obtain other portions of the market data from third party market data sources. Such data often has multiple dimensions (i.e., categories of data). Some market data sets may include, for example, a time dimension, an income dimension, a costs dimension, a profits dimension, a sales dimension, an advertising dimension, a geographical region dimension, or some combination thereof.

Sometimes, market data may be presented as a denormalized “perfect” dataset. A perfect market data set is a market data set that is arranged in a table (e.g., a pivot table) or database in which no data is missing (e.g. all identified totals match a sum of all identified subordinate subtotals) and all data is provided at uniform granularity by dimension. Often, a perfect market data set is required by analytic visualization software in order to generate charts or other analytic visualizations.

More often, market data is provided as an “imperfect” dataset instead, in which certain types or dimensions of data are incomplete, missing, or provided at a different granularity. Imperfect data can result from many common situations, such as a user purchasing multiple market data sets at different granularities (e.g. a user purchases the right to view daily ice cream sales but only monthly soda sales) or an aggregator mixing data of different granularities (e.g., when some of the market data set has been generated by the aggregator and some has been provided to the aggregator by a third party market data source, or when the market data set includes data from two or more distinct third party market data sources). Often, imperfect data may be inhomogeneous, unevenly distributed, and have differing granularity by dimensions. Imperfect data often causes issues for a user and/or a computer trying to analyze the data (e.g., to generate pivot tables or charts or other analytic visualizations), such as causing errors resulting from missing data and rounding errors, wasting memory or storage space or processing time by storing and repeatedly processing useless or redundant data (e.g. useless or redundant rows or columns), or other issues. Generally, such market data sets are massive and very time-consuming to review, analyze, edit, or correct. Furthermore, they often include a high number of dimensions and hierarchies that may make them inaccessible via certain devices or software applications due to compatibility or memory issues, and may make them difficult or impossible to manipulate into more easily-understandable formats, such as charts, that often rely on uniform granularity of data.

Typically, converting an imperfect market data set into a perfect data set requires time-consuming, inefficient, slow, and painstaking manual data manipulation that can be simply infeasible given large market data sets (e.g., pertaining to large worldwide sales markets).

Therefore, there is a need for improved systems and methods for enhancing imperfect market data.

### SUMMARY OF THE CLAIMED INVENTION

One exemplary method for processing market data includes receiving an imperfect market data set, the imperfect market data set including a plurality of data entries that each include a numerical value, the plurality of data entries including a plurality of leaf data entries whose numerical values are independent, the plurality of data entries also including a plurality of non-leaf data entries, wherein the numerical value associated with each non-leaf data entry is based at least partially on one or more child numerical values of at least a set of one or more child data entries selected from the set of data entries. The method also includes identifying one or more missing numerical values by calculating a difference between the numerical value of each non-leaf data entry and a mathematical operation performed using of the numerical values of its associated set of one or more child data entries. The method also includes generating one or more new data entries such that each new data entry includes one missing numerical value of the one or more missing numerical values, wherein the one or more new data entries are leaf data entries. The method also includes inserting the one or more new data entries into the imperfect market data set. The method also includes generating a perfect market data set by removing the plurality of non-leaf data entries from the imperfect market data set following insertion of the one or more new data entries. The method also includes outputting information from the perfect market data set at a user device.

One exemplary system for processing market data includes a communication transceiver. The a communication transceiver receives receiving an imperfect market data set, the imperfect market data set including a plurality of data entries that each include a numerical value, the plurality of data entries including a plurality of leaf data entries whose numerical values are independent, the plurality of data entries also including a plurality of non-leaf data entries, wherein the numerical value associated with each non-leaf data entry is based at least partially on one or more child numerical values of at least a set of one or more child data entries selected from the set of data entries. The system also includes a memory for storing at least the imperfect market data set. The system also includes a processor coupled to the memory and to the communication transceiver. Execution of instructions stored in the memory by the processor performs various system operations. The system operations include identifying one or more missing numerical values by calculating a difference between the numerical value of each non-leaf data entry and a mathematical operation performed using of the numerical values of its associated set of one or more child data entries. The system operations also include generating one or more new data entries such that each new data entry includes one missing numerical value of the one or more missing numerical values, wherein the one or more new data entries are leaf data entries. The system operations also include inserting the one or more new data entries into the imperfect market data set. The system operations also include generating a perfect market data set by removing the plurality of non-leaf data entries from the imperfect market data set following insertion of the one or more new data entries. The system operations also include outputting information from the perfect market data set.

One exemplary non-transitory computer-readable storage medium may have embodied thereon a program executable by a processor to perform a method for processing market data. The exemplary program method includes receiving an imperfect market data set, the imperfect market data set including a plurality of data entries that each include a numerical value, the plurality of data entries including a plurality of leaf data entries whose numerical values are independent, the plurality of data entries also including a plurality of non-leaf data entries, wherein the numerical value associated with each non-leaf data entry is based at least partially on one or more child numerical values of at least a set of one or more child data entries selected from the set of data entries. The program method also includes identifying one or more missing numerical values by calculating a difference between the numerical value of each non-leaf data entry and a mathematical operation performed using of the numerical values of its associated set of one or more child data entries. The program method also includes generating one or more new data entries such that each new data entry includes one missing numerical value of the one or more missing numerical values, wherein the one or more new data entries are leaf data entries. The program method also includes inserting the one or more new data entries into the imperfect market data set. The program method also includes generating a perfect market data set by removing the plurality of non-leaf data entries from the imperfect market data set following insertion of the one or more new data entries. The program method also includes outputting information from the perfect market data set at a user device.

### BRIEF DESCRIPTION OF THE FIGURES

FIG. 1 is a flow diagram illustrating processing of data from one or more data sources to a user-friendly reporting of the data.

FIG. 2 illustrates extraction of data from various exemplary data sources.

FIG. 3 illustrates a data packing data enhancement operation performed to enhance an exemplary imperfect market data set that includes only labels.

FIG. 4 illustrates a data packing data enhancement operation and a differential data correction operation performed to enhance and correct an exemplary imperfect market data set that includes both labels and values

FIG. 5A illustrates an exemplary user device performing data enhancement and correction operations.

FIG. 5B illustrates an exemplary user device communicatively coupled to one or more servers performing data enhancement and correction operations.

FIG. 6 is a block diagram of an exemplary computing device that may be used to implement an embodiment of the present invention.

FIG. 7 illustrates exemplary charts to be generated based on the perfect market data.

### DETAILED DESCRIPTION

Market data is often provided as inhomogeneous imperfect data with inconsistent granularity and hierarchical entries. Data processing operations may be performed by a user device or by a server coupled to a user device to transform the imperfect market data into perfect market data with consistent granularity where all entries are leaf nodes with no subordinate entries. The data processing includes data correction operations identify provided parent values of parent entries, the parent values based on sets of child values of child entries that are subordinate to the corresponding parent entry (e.g., representing sums, products, minimums, maximums, etc. of the child values) and compare these parent values to calculated values of corresponding operations performed on the provided child values. Additional entries may be generated to absorb any discrepancies identified in these comparisons. Parent nodes can then be removed to remove redundant information and provide uniformity to the market data.

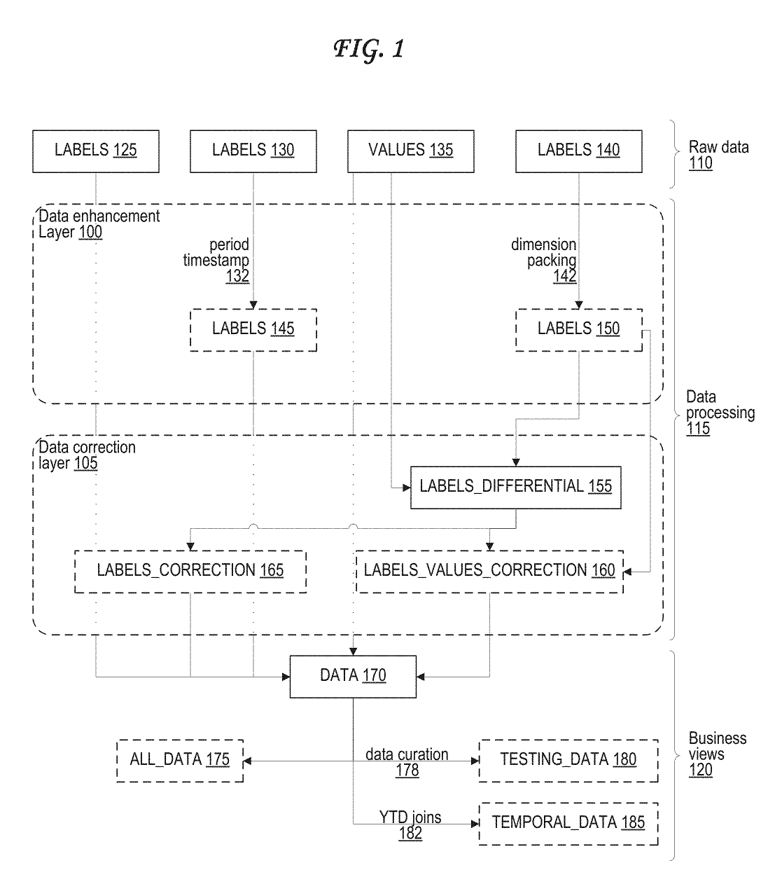

FIG. 1 is a flow diagram illustrating processing of data from one or more data sources to a user-friendly reporting of the data.

The embodiment of FIG. 1 illustrates raw data 110, which, after data processing operations 115, is converted into “perfect” data form and output as business views 120. The raw data 110 includes various labels, including labels 125, labels 130, and labels 140. The raw data 110 also includes values 135. The data processing operations 115 include a data enhancement layer 100 and a data correction layer 105. The business views 120 may include an aggregate resulting data set 170 that includes the results of passing the raw data 110 through the data processing operations 115 as well as various analytics, tables, and analytic visualizations based on the aggregate resulting data set 170.

The labels 125 are not altered during the data processing 115 operations (e.g., the labels 125 may already be formatted in a “perfect” manner) and thus are added into an aggregate resulting data set 170.

The labels 130 are altered at the data enhancement layer 100 via the addition of period timestamp(s) 132, thus generating enhanced labels 145. The enhanced labels 145 are then added into the aggregate resulting data set 170.

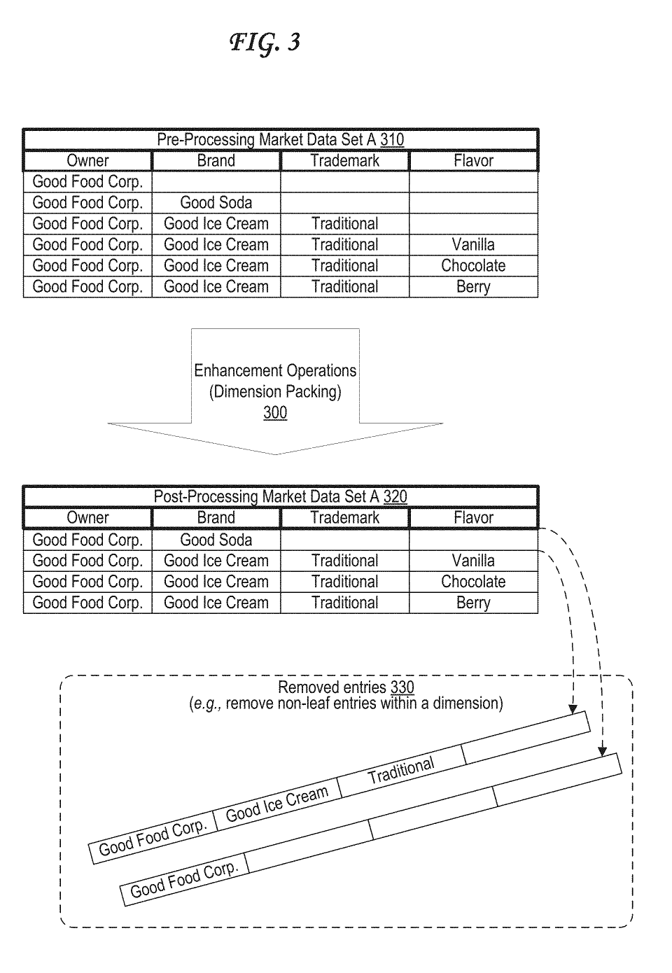

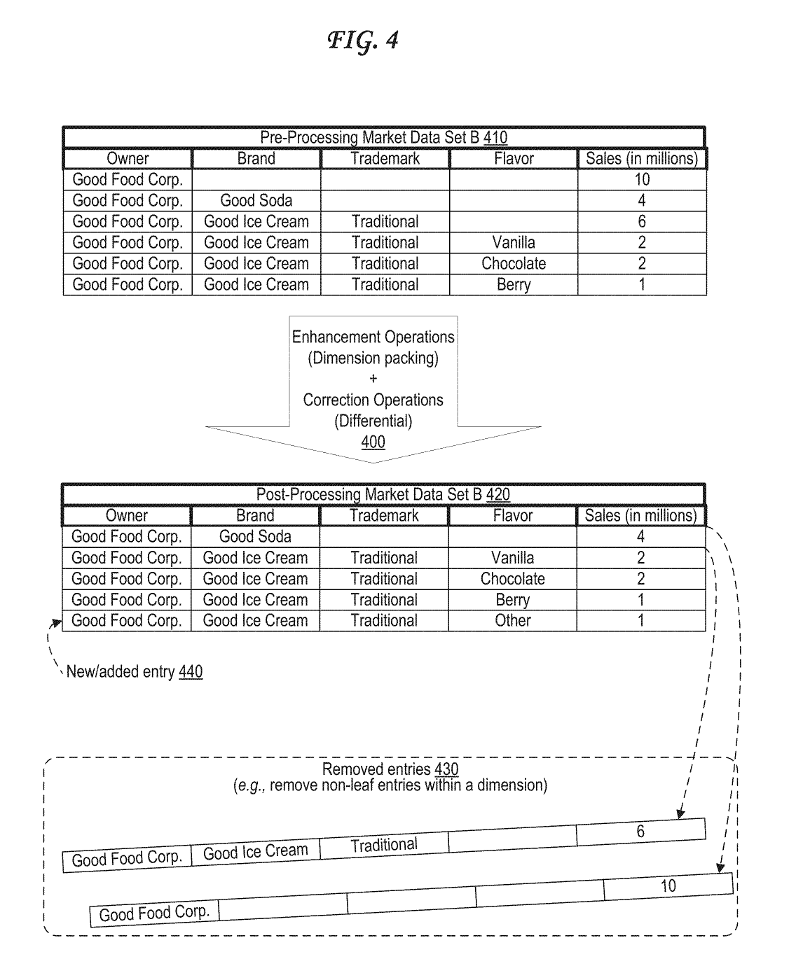

The labels 140 are altered at the data enhancement layer 100 via dimension packing 142 (e.g., see FIG. 3), thus generating enhanced labels 150. The enhanced labels 150 are then altered at the data correction layer 105 via differential correction operations 155 (e.g. see FIG. 4) to generated corrected labels 165. The corrected labels 165 are then added into the aggregate resulting data set 170.

The values 135 are altered at the data correction layer 105 via differential correction operations 155 (e.g., see FIG. 4) to generated corrected values 160. The corrected values 160 are then added into the aggregate resulting data set 170.

The aggregate resulting data set 170 includes the raw data 110 as enhanced and corrected via the data processing operations 115.

Based on the aggregate resulting data set 170, a user using a user device 500 can view an analytic visualization, such as a chart or a table, based on all of the data from the aggregate resulting data set 170 (i.e., ALL_DATA 175), a curated set of data (e.g., TESTING_DATA 180) following manual or automated data curation operations 178, or a time-focused data set (e.g., TEMPORAL_DATA 185) of data following time-based operations (e.g., YTD “Year-to-Date” joins 182).

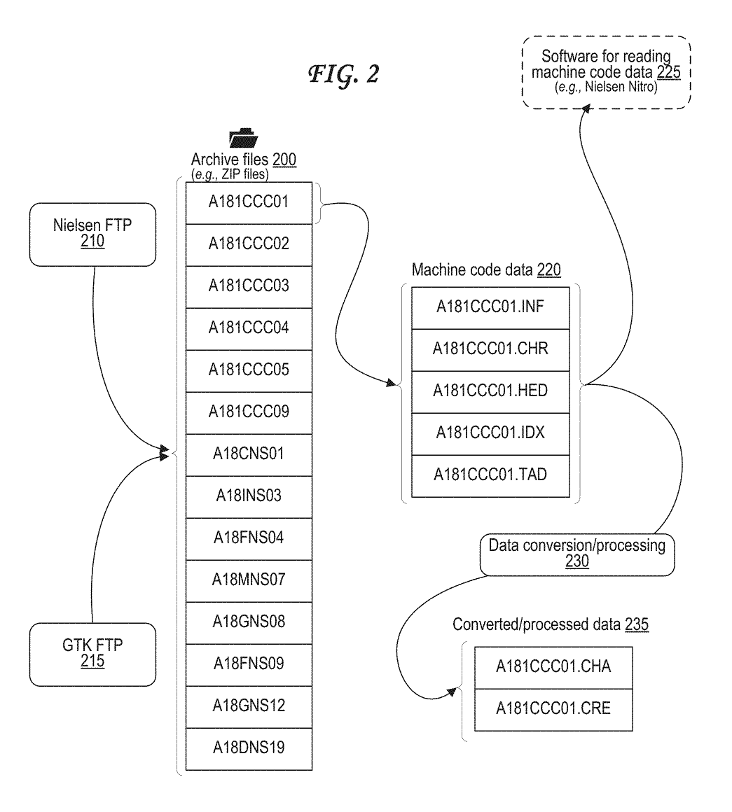

FIG. 2 illustrates extraction of data from various exemplary data sources.

The data of FIG. 2 is provided in archive files 200 (e.g., ZIP files, RAR files, TAR files, 7Z files, ISO files, BIN/CUE files) retrieved from File Transfer Protocol (FTP) data sources (e.g., Nielsen FTP 210, GTK FTP 215).

The archive files 200 are extracted to produce machine code data files, which may include data in file formats such as INF, CHR, HED, IDX, or TAD. In FIG. 2, one of the archive files (“A181CCC01”) is shown as extracted into a particular set of machine code data 220 with files A181CCC01.INF, A181CCC01.CHR, A181CCC01.HED, A181CCC01.IDX, and A181CCC01.TAD.

At least a subset of the machine code data 220 may be read by software intended for reading machine code data 225, such as Nielsen Nitro.

At least a subset of the machine code data 220 may be passed through a data conversion and/or processing operations 230 (e.g., including data processing operations 115 of FIG. 1 as well as file format conversions) to generated converted/processed data 235. The converted/processed data 235 of FIG. 2 includes files A181CCC01.CHA and A181CCC01.CRE.

FIG. 3 illustrates a data packing data enhancement operation performed to enhance an exemplary imperfect market data set that includes only labels.

In particular, FIG. 3 illustrates generation of a post-processing market data set A 320 via dimension packing data enhancement operations 300 performed on a pre-processing market data set A 310. The dimension packing enhancement operations 300 remove two entries, identified as removed entries 330.

In some imperfect datasets, certain dimensions or entries in a database are organized in a parent-child relationship, as in a tree with subordinate nodes. A perfect dataset should not have such parent-child relationships in entries or in dimensions, and should only include “leaf” entries—that is, the most-subordinate nodes that themselves have no other subordinate “child” nodes. Any entries representing higher-level information can be removed to decrease the size of the resulting perfect dataset, so as to decrease the amount of space it takes up in data storage (e.g., on a hard drive, in flash or other solid state storage drive, on a removable storage medium, or some combination thereof), increase the amount of the data that can be maintained in memory (e.g., Random Access Memory) or a hardware-based or operating-system-based cache, and speed up processing and searches without losing any actual information. Thus, the removed entries 330 of FIG. 3 include the first entry of the Pre-Processing Market Data Set A 310, which was very high-level and only identified the owner (and essentially a “parent entry” to the second and third entries, which are its corresponding “child” entries), and the third entry of the Pre-Processing Market Data Set A 310, which was of an intermediate level and essentially a parent entry to the fourth, fifth, and sixth entries, which are “child” entries corresponding to the third entry. The second, fourth, fifth, and sixth entries were not among the removed entries 330 because they were each “leaf” entries with no subordinate entries.

FIG. 4 illustrates a data packing data enhancement operation and a differential data correction operation performed to enhance and correct an exemplary imperfect market data set that includes both labels and values.

In particular, FIG. 4 illustrates generation of a post-processing market data set B 420 via dimension packing data enhancement and differential data correction operations 400 performed on a pre-processing market data set B 410. The dimension packing enhancement operations 400 remove two entries, identified as removed entries 430, and the differential data correction operations add a single entry, identified as the newly added entry 440.

The dimension packing enhancement operations 400 work much as they did in FIG. 3, once again removing the first and third entries from the pre-processing market data set B 410 due to those entries not being “leaf” entries but “parent” entries. The parent status of these entries is more visible in pre-processing market data set B 410 than it was in pre-processing market data set A 310, as pre-processing market data set B 410 includes a “sales” dimension column that identifies a numerical value representing a sales figures, for example in hundreds or thousands or millions (e.g., millions in FIG. 4).

The “sales” value of the first entry of the pre-processing market data set B 410 of the pre-processing market data set B 410 is the sum of the “sales” values for the second and third entries, as the first entry of the pre-processing market data set B 410 is a “parent” entry to the second and third entries (the “child” entries of the first entry). Therefore, the processing 400 simply removes the first entry during the dimension packing enhancement operations but leaves the second and third entries, which are “leaf” entries.

The “sales” value of the third entry of the pre-processing market data set B 410 of the pre-processing market data set B 410 should be equal to the sum of the “sales” values for the fourth, fifth, and sixth entries, but appears to be off by one (e.g., off by one million sales in this case). This can be the result of one or more missing “child” entries (e.g., indicating that the initial data was faulty and did not include these one or more missing “child” entries or perhaps that a user did not purchase the rights to those additional “child” entries) or can alternately be the result of a rounding error (e.g., perhaps the Vanilla ice cream of the fourth entry actually sold 2½ million, the Chocolate ice cream of the fifth entry also sold 2½ million, and the Berry ice cream of the sixth entry sold 1⅓ million, but each were rounded down to an integer number). Because it not always clear whether the missing “sales” values are the result of missing data or a rounding error, the differential data correction of the processing operations 400 adds a new child/leaf entry 440 labeled “other” representing the missing 1 million sales. The data packing data enhancement then removes the third entry from the pre-processing market data set B 410, since the third entry is a parent entry rather than a leaf entry, and since the addition of the newly added entry 440 means that the third entry from the pre-processing market data set B 410 does not provide any information not already represented.

The numerical values (i.e., the sales values) of the parent entries FIG. 4, or the “parent values,” are based on the numerical values of a set of child entries (the “child values”) corresponding to that parent entry. In particular, the parent values of FIG. 4 represent sums of sets of child values. For example, the first entry of the pre-processing market data set B 410 is the parent of the second and third entries, and its parent value (10) is the sum of the child value of the second entry (4) and the child value of the third entry (6). The third entry of the pre-processing market data set B 410, in turn, is the parent of the fourth, fifth, and sixth entries, and the parent value of the third entry (6) is the sum of the child value of the fourth entry (2), the child value of the fifth entry (2), the child value of the sixth entry (1), and the child value of a missing entry (1) that turned into the newly added entry 440 during the processing operations 400. In other embodiments (not pictured), parent values of parent entries may not be the sum of their corresponding set of child values, but may instead the characterized by the result of another operation on the corresponding set of child values, such as a product, a maximum, a minimum, a mean, a median, a mode, a standard deviation, a range, a value corresponding to a predetermined position according to an ordering of the one or more subordinate child numerical values (e.g., a first child, a last child, or an Nth child), a factorial, or some combination thereof.

In another embodiment (e.g., if it can be determined which entry or entries most likely suffered from a rounding error and/or when such rounding errors can be approximated mathematically), missing data may be added to one or more existing entries without addition of a new entry such as newly added entry 440. A software application performing such differential data correction may use context to determine which approach is more suitable for a given situation, or may alternately be “hardwired” to use one approach or the other.

The post-processing market data set B 420 of FIG. 4 is an example of a “perfect” market data set. Often, market data sets are massive and occupy very large amounts of memory (e.g., numerous megabytes, multiple gigabytes, terabytes, petabytes, exabytes). Therefore, removing entries can provide considerable speed boosts in future computer operations. Simplifying dimensions/granularity by reducing the number of non-leaf data entries in favor of leaf data entries can also provide considerable speed boosts in future computing operations, and can also provide a number of functional benefits. For example, compatibility with some devices or software applications can be increased, as some devices or applications only accept data at more simplified granularity/dimensionality levels. For example, inputting imperfect market data with numerous levels of parent-child hierarchies into a chart or graph generating software application generally will not allow generation of a chart or graph, whereas inputting perfect market data that has been reduced to leaf data entries at uniform granularity/dimensionality may be used to generate a chart or graph.

Having market data processed and organized in this manner may provide improvements to computing functionality and speed, since

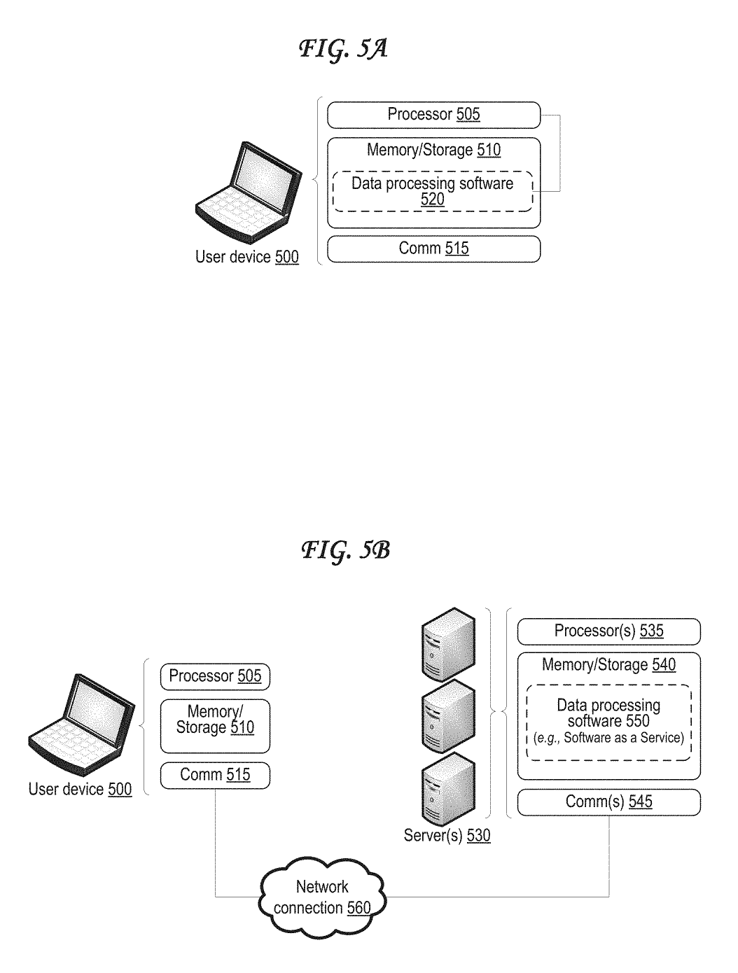

FIGS. 5A and 5B illustrate exemplary hardware layouts for performance of data enhancement and correction.

FIG. 5A illustrates an exemplary user device performing data enhancement and correction operations.

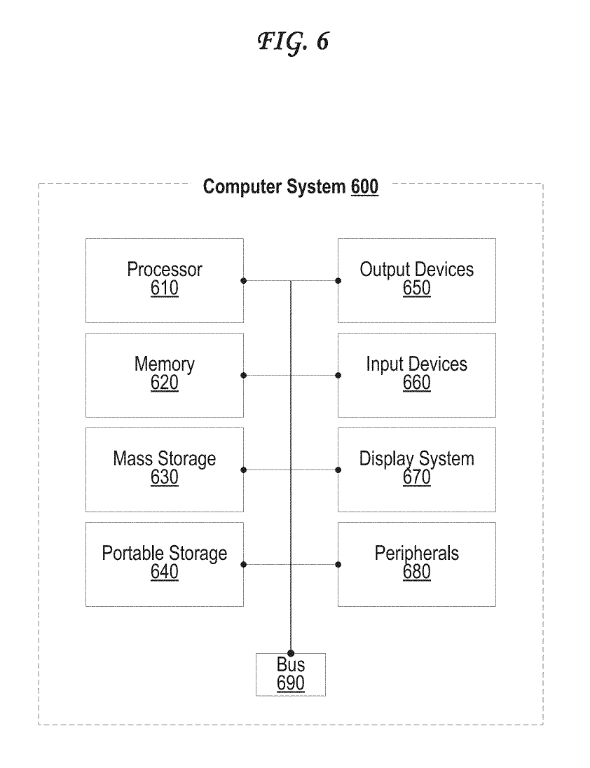

The user device 500 of FIG. 5A may be a variant of computer system 600 identified in FIG. 6 or its description, or may include at least a subset of the hardware components and software elements identified in FIG. 6 or its description. The user device 500 may include one or more memory and/or data storage module(s) 510 (e.g. which may include any kind of memory 620, mass storage 630, portable storage 640, or some combination thereof), one or more processor(s) 505 (e.g. processor 610), one or more input mechanism(s) (e.g. one or more input devices 660), one or more display screen(s) (e.g., such as display system 670), or some combination thereof. The user device 500 may include one or more communication element(s) 515 which may include a communication receiver, a communication transmitter, a communication transceiver, or some combination thereof, and which may send and/or receive data using wired data transfer methods (e.g., Ethernet, “USB” Universal Serial Bus cable, “HDMI” High-Definition Multimedia Interface cable, Apple lightning cable), wireless data transfer methods (e.g., Bluetooth, 802.11 Wi-Fi, 3G/4G/5G/LTE cellular networks), or some combination thereof. The user device 500 may be a physical system or a virtual system.

The memory/storage module(s) 510 of the user device 500 may include a data processing software 520 for executing data processing operations 115, including data enhancement 100 (e.g., dimension packing 142 as illustrated in operations 300 of FIG. 3 and operations 400 of FIG. 4) and data correction 105 (e.g., differential data correction 155 as illustrated in operations 400 of FIG. 4).

FIG. 5B illustrates an exemplary user device communicatively coupled to one or more servers performing data enhancement and correction operations.

The server(s) 530 may include at least one variant of computer system 600 identified in FIG. 6 or its description, or may include at least a subset of the hardware components and software elements identified in FIG. 6 or its description. The server(s) 530 may include one or more memory and/or data storage module(s) 540 (e.g., which may include any kind of memory 620, mass storage 630, portable storage 640, or some combination thereof), one or more processor(s) 535 (e.g. processor 610), one or more input mechanism(s) (e.g., one or more input devices 660), one or more display screen(s) (e.g., such as display system 670), or some combination thereof. The server(s) 530 may include one or more communication element(s) 545 which may include a communication receiver, a communication transmitter, a communication transceiver, or some combination thereof, and which may send and/or receive data using wired data transfer methods (e.g., Ethernet, “USB” Universal Serial Bus cable, “HDMI” High-Definition Multimedia Interface cable, Apple lightning cable), wireless data transfer methods (e.g., Bluetooth, 802.11 Wi-Fi, 3G/4G/5G/LTE cellular networks), or some combination thereof. The server(s) 530 may include one or more such systems, which may be privately networked or distributed (e.g., throughout the Internet) or some combination thereof, and which may include physical systems or virtual systems or some combination thereof.

The memory/storage module(s) 540 of the server(s) 530 may include a data processing software 550 for executing data processing operations 115, including data enhancement 100 (e.g., dimension packing 142 as illustrated in operations 300 of FIG. 3 and operations 400 of FIG. 4) and data correction 105 (e.g., differential data correction 155 as illustrated in operations 400 of FIG. 4). The data processing software 550 may interact with the user device 500 by transferring data to the user device 500 and/or receiving data from the user device 500, may support or be supported by other software applications executed by the user device 500, and may operate in a “Software as a Service” fashion.

The user device 500 may be communicatively coupled to at least a subset of the one or more server(s) 530 via a network connection 560. The network connection 560 may include one or more private network connections, such as a Local Area Network (“LAN”) connection, a Wireless Local Area Network (“WLAN”) connection, a Municipal Area Network (“MAN”) connection, or a Wide Area Network (“WAN”) connection (e.g., when the user device 500 is in the same private network as at least a subset of the servers 530). The network connection 560 may also include a connection passing through the public Internet. In some cases, the network connection 560 may be secured with secure protocols (e.g., using “SSL” Secure Socket Layer and/or “TLS” Transport Layer Security), passwords, public and/or private keys, certificates signed by certificate authorities, or some combination thereof.

In an alternate embodiment (not shown), the user device 500 may include some portion of a data processing software 520 and the server(s) 530 may also include some portion of a data processing software 550. Certain data processing operations may be performed by the user device 500 while other data processing operations are performed by the server(s) 530.

FIG. 6 illustrates an exemplary computing system 600 that may be used to implement an embodiment of the present invention. For example, any of the computer systems or computerized devices described herein may, in at least some cases, be a computing system 600. The computing system 600 of FIG. 6 includes one or more processors 610 and memory 610. Main memory 610 stores, in part, instructions and data for execution by processor 610. Main memory 610 can store the executable code when in operation. The system 600 of FIG. 6 further includes a mass storage device 630, portable storage medium drive(s) 640, output devices 650, user input devices 660, a graphics display 670, and peripheral devices 680.

The components shown in FIG. 6 are depicted as being connected via a single bus 690. However, the components may be connected through one or more data transport means. For example, processor unit 610 and main memory 610 may be connected via a local microprocessor bus, and the mass storage device 630, peripheral device(s) 680, portable storage device 640, and display system 670 may be connected via one or more input/output (I/O) buses.

Mass storage device 630, which may be implemented with a magnetic disk drive or an optical disk drive, is a non-volatile storage device for storing data and instructions for use by processor unit 610. Mass storage device 630 can store the system software for implementing embodiments of the present invention for purposes of loading that software into main memory 610.

Portable storage device 640 operates in conjunction with a portable non-volatile storage medium, such as a floppy disk, compact disk or Digital video disc, to input and output data and code to and from the computer system 600 of FIG. 6. The system software for implementing embodiments of the present invention may be stored on such a portable medium and input to the computer system 600 via the portable storage device 640.

Input devices 660 provide a portion of a user interface. Input devices 660 may include an alpha-numeric keypad, such as a keyboard, for inputting alpha-numeric and other information, or a pointing device, such as a mouse, a trackball, stylus, or cursor direction keys. Additionally, the system 600 as shown in FIG. 6 includes output devices 650. Examples of suitable output devices include speakers, printers, network interfaces, and monitors.

Display system 670 may include a liquid crystal display (LCD), a plasma display, an organic light-emitting diode (OLED) display, an electronic ink display, a projector-based display, a holographic display, or another suitable display device. Display system 670 receives textual and graphical information, and processes the information for output to the display device. The display system 670 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 680 may include any type of computer support device to add additional functionality to the computer system. For example, peripheral device(s) 680 may include a modem or a router.

The components contained in the computer system 600 of FIG. 6 are those typically found in computer systems that may be suitable for use with embodiments of the present invention and are intended to represent a broad category of such computer components that are well known in the art. Thus, the computer system 600 of FIG. 6 can be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer system 600 may in some cases be a virtual computer system executed by another computer system. The computer can also include different bus configurations, networked platforms, multi-processor platforms, etc. Various operating systems can be used including Unix, Linux, Windows, Macintosh OS, Palm OS, Android, iOS, and other suitable operating systems.

In some cases, the computer system 600 may be part of a multi-computer system that uses multiple computer systems 600 (e.g., for one or more specific tasks or purposes). For example, the multi-computer system may include multiple computer systems 400 communicatively coupled together via one or more private networks (e.g., at least one LAN, WLAN, MAN, or WAN), or may include multiple computer systems 600 communicatively coupled together via the internet (e.g., a “distributed” system), or some combination thereof.

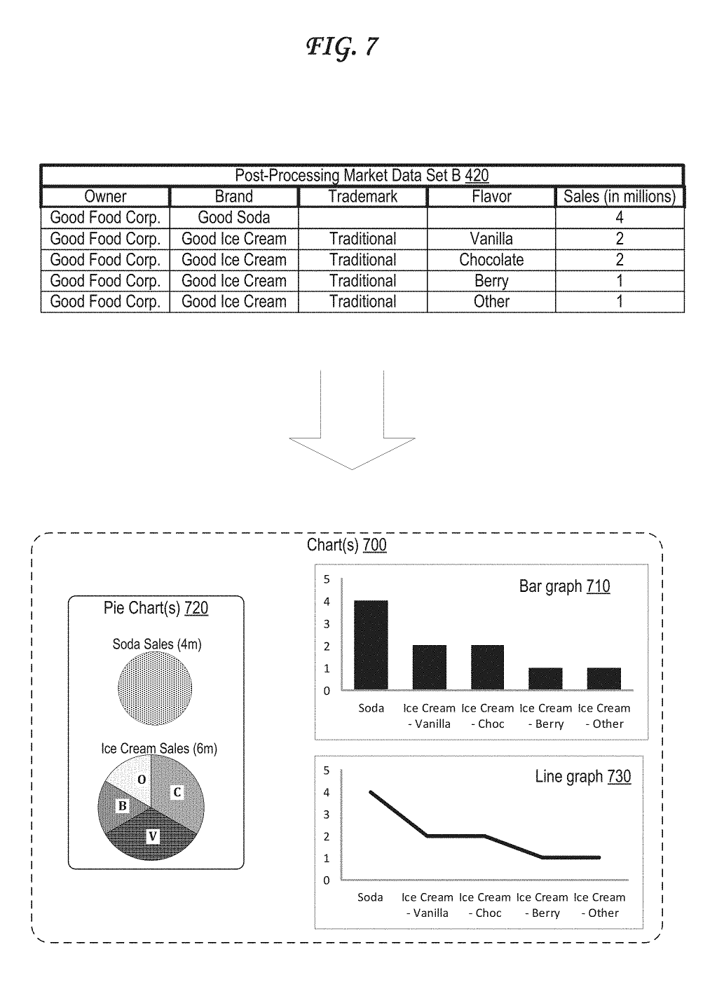

FIG. 7 illustrates exemplary charts to be generated based on the perfect market data.

In particular, FIG. 7 illustrates one or more chart(s) 700 generated based on the post-processing market data set B 420 of FIG. 4. The one or more chart(s) 700 may include, for example, one or more bar graph(s) 710, one or more line graph(s) 730, one or more pie chart(s) 720, or some combination thereof. One perfect market data set may generate a single chart, as illustrated in bar graph 710. One perfect market data set may alternately generate multiple charts, for example one for each of a particular category/column/dimension (e.g., in this case one for each owner, one for each brand, one for each trademark), as illustrated by the two pie charts 720 which represent separate brands and whose visual size is based on how much total money each represents (e.g., the “good soda” pie chart is smaller than the “good ice cream” pie chart because the “good soda” sales total is $4 million and the “good ice cream” sales total is $6 million). Other data (not shown) from outside a perfect market data set (e.g., post-processing market data set B 420) may also be included in one of the charts 700.

Outputting the post-processing market data set B 420 at a user device may include displaying the post-processing market data set B 420 in table form (e.g., via a display system 670), or may include displaying one or more of the charts 700 (e.g., via a display system 670), or may include outputting audio based on the post-processing market data set B 420 via a text-to-speech function and one or more speakers, or some combination thereof.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A method for processing market data, the method comprising:
receiving an imperfect market data set, the imperfect market data set including a plurality of data entries that each include a numerical value, the plurality of data entries including a plurality of leaf data entries whose numerical values are independent, the plurality of data entries also including a plurality of non-leaf data entries, wherein the numerical value associated with each non-leaf data entry is based at least partially on one or more child numerical values of at least a set of one or more child data entries selected from the set of data entries;
identifying one or more missing numerical values by calculating a difference between the numerical value of each non-leaf data entry and a mathematical operation performed using of the numerical values of its associated set of one or more child data entries;
generating one or more new data entries such that each new data entry includes one missing numerical value of the one or more missing numerical values, wherein the one or more new data entries are leaf data entries;
inserting the one or more new data entries into the imperfect market data set;
generating a perfect market data set by removing the plurality of non-leaf data entries from the imperfect market data set following insertion of the one or more new data entries; and
outputting information from the perfect market data set at a user device.

2. The method of claim 1, wherein the mathematical operation includes at least one of a sum, a product, a maximum, a minimum, a mean, a median, a mode, a standard deviation, a range, a factorial, or some combination thereof.

3. The method of claim 1, wherein outputting the information from the perfect market data set at the user device includes displaying at least the information from the perfect market data set via a display component of the user device, the display component being one of a display screen, a projector display, a headset display, a glasses-based display, or a holographic display.

4. The method of claim 1, wherein outputting the information from the perfect market data set at the user device includes playing audio based on the information from the perfect market data set via one or more speakers of the user device.

5. The method of claim 1, wherein outputting the information from the perfect market data set at the user device includes:
generating one or more charts based at least partially on the information from the perfect market data set, wherein the one or more charts include at least one of a pie chart, a bar graph, a line graph, or some combination thereof; and
outputting at least the one or more charts at the user device.

6. The method of claim 1, wherein outputting the information from the perfect market data set at the user device includes transmitting the information from the perfect market data set to the user device via a network connection, the network connection including wired communications, wireless communications, or some combination thereof.

7. The method of claim 1, wherein receiving the imperfect market data set includes receiving one or more files via one of File Transfer Protocol (FTP), Secure File Transfer Protocol (SFTP), or some combination thereof.

8. The method of claim 1, wherein receiving the imperfect market data set includes extracting one or more archive files.

9. The method of claim 1, wherein receiving the imperfect market data set includes using a machine code reading algorithm to read one or more data files.

10. The method of claim 1, wherein receiving the imperfect market data set includes converting one or more files from a first format into a second format.

11. A system for processing market data, the system comprising:
a communication transceiver that receives an imperfect market data set, the imperfect market data set including a plurality of data entries that each include a numerical value, the plurality of data entries including a plurality of leaf data entries whose numerical values are independent, the plurality of data entries also including a plurality of non-leaf data entries, wherein the numerical value associated with each non-leaf data entry is based at least partially on one or more child numerical values of at least a set of one or more child data entries selected from the set of data entries;
a memory that stores at least the imperfect market data set;
a processor coupled to the memory and to the communication transceiver, wherein execution of instructions stored in the memory by the processor:
identifies one or more missing numerical values by calculating a difference between the numerical value of each non-leaf data entry and a mathematical operation performed using of the numerical values of its associated set of one or more child data entries,
generates one or more new data entries such that each new data entry includes one missing numerical value of the one or more missing numerical values, wherein the one or more new data entries are leaf data entries, inserts the one or more new data entries into the imperfect market data set,
generates a perfect market data set by removing the plurality of non-leaf data entries from the imperfect market data set following insertion of the one or more new data entries, and
outputs information from the perfect market data set.

12. The system of claim 11, wherein the mathematical operation includes at least one of a sum, a product, a maximum, a minimum, a mean, a median, a mode, a standard deviation, a range, a factorial, or some combination thereof.

13. The system of claim 11, further comprising a display component, wherein outputting the information from the perfect market data set includes displaying at least the information from the perfect market data set via the display component, wherein the display component is one of a display screen, a projector display, a headset display, a glasses-based display, or a holographic display

14. The system of claim 11, further comprising one or more speakers, wherein outputting the information from the perfect market data set includes playing audio based on the information from the perfect market data set via the one or more speakers.

15. The system of claim 11, wherein outputting the information from the perfect market data set includes:
generating one or more charts based at least partially on the information from the perfect market data set, wherein the one or more charts include at least one of a pie chart, a bar graph, a line graph, or some combination thereof, and
outputting at least the one or more charts.

16. The system of claim 11, wherein outputting the information from the perfect market data set includes transmitting the information from the perfect market data set to a user device via a network connection using the communication transceiver, the network connection including wired communications, wireless communications, or some combination thereof.

17. The system of claim 11, wherein receiving the imperfect market data set includes receiving one or more files through the communication transceiver via one of File Transfer Protocol (FTP), Secure File Transfer Protocol (SFTP), or some combination thereof.

18. The system of claim 11, wherein receiving the imperfect market data set includes extracting one or more archive files.

19. The system of claim 11, wherein receiving the imperfect market data set includes converting one or more files from a first format into a second format.

20. A non-transitory computer-readable storage medium, having embodied thereon a program executable by a processor to perform a method for processing market data, the method comprising:
receiving an imperfect market data set, the imperfect market data set including a plurality of data entries that each include a numerical value, the plurality of data entries including a plurality of leaf data entries whose numerical values are independent, the plurality of data entries also including a plurality of non-leaf data entries, wherein the numerical value associated with each non-leaf data entry is based at least partially on one or more child numerical values of at least a set of one or more child data entries selected from the set of data entries;
identifying one or more missing numerical values by calculating a difference between the numerical value of each non-leaf data entry and a mathematical operation performed using of the numerical values of its associated set of one or more child data entries;
generating one or more new data entries such that each new data entry includes one missing numerical value of the one or more missing numerical values, wherein the one or more new data entries are leaf data entries;
inserting the one or more new data entries into the imperfect market data set;
generating a perfect market data set by removing the plurality of non-leaf data entries from the imperfect market data set following insertion of the one or more new data entries; and
outputting information from the perfect market data set.
